(19) United States
(12) Patent Application Publication
(10) Pub. No.: US 2025/0100647 A1
(43) Pub. Date: Mar. 27, 2025

(54) Convertible Flotation Carrier For Towing Bicycles And Kayaks

(71) Applicant: Edward A Smith, Providence, RI (US)

(72) Inventor: Edward A Smith, Providence, RI (US)

(21) Appl. No.: 18/709,454

(22) PCT Filed: Nov. 11, 2022
(86) PCT No.: PCT/US2022/049723

§ 371 Date: May 10, 2024

Related U.S. Application Data
(60) Provisional application No. 63/278,385, filed on Nov. 11, 2021.

(51) Int. Cl. B62K 27/00; B60P 3/10; B63B 34/26

(52) U.S. Cl. CPC B62K 27/003; B63B 34/26; B60P 3/1033

(57) ABSTRACT

A convertible flotation carrier having an upper and lower sub-assembly is provided. The lower assembly preferably has a twin hull structure with a cradle portion lying between the hulls. The flotation carrier can be used to support a kayak, and a bicycle can easily tow the flotation carrier supporting the kayak over land. In turn, the flotation carrier can be converted to a watertight, buoyant container for the bicycle and the kayak can easily tow the flotation carrier containing the bicycle in the water.

### CROSS-REFERENCE TO RELATED APPLICATIONS

The application claims the benefit of PCT International Application No. PCT/US2022/049723 filed Nov. 11, 2022, which claims the benefit of U.S. Provisional Patent Application No. 63/278,385 filed Nov. 11, 2021, the entire disclosures of which are hereby incorporated by reference.

### BACKGROUND OF THE INVENTION

### Field of the Invention

The present invention relates generally to a convertible flotation carrier. The flotation carrier can be used to support a kayak, and a bicycle can easily tow the flotation carrier supporting the kayak over land. In turn, the flotation carrier can be converted to support the bicycle and the kayak can easily tow the flotation carrier in the water.

### Brief Review of the Related Art

Normally, a person uses a vehicle such as a truck or car to transport a kayak to oceans, lakes, rivers, ponds, and the like. He/she loads the kayak into a truck bed or onto a roof rack and drives to the waterway. In other instances, a person loads the kayak onto a trailer and tows the kayak behind the truck or car until he/she reaches the water. This can be a time-consuming and cumbersome process. The kayaker must first find a parking area for the vehicle, unload the kayak, and then launch it in the water. Finally, the kayaker can start paddling and begin their journey. Eventually, the kayaker must return to the same location, where he/she originally started. The kayaker must turn around and paddle back to their starting point. Then, the kayaker must remove the kayak from the water and load it back into the vehicle. The kayaker also must remove and handle any gear from the kayak.

In some instances, for example, when there is a strong current in the river, the kayaker will leave the water after reaching a certain point and carry the kayak over land. This transporting of the kayak can be a difficult process, because it often means flipping the kayak upside down and carrying it overhead. The lifting and carrying of the kayak are particularly difficult when equipment must be carried with the kayak.

In yet other instances, a second individual will drive the vehicle from the original water departure point, follow the kayaker by land, and eventually meet-up with the kayaker at the water destination point. There, the second person can help the kayaker remove the kayak from the water and load it and any other equipment into the vehicle.

In recent years, bicycles have been used for towing kayaks. The bicycles offer several advantages, for example, they are environmental-friendly. The bicycles also can be used off-road, for example, on dirt and mountain paths. In this way, bicycles can be used to transport the kayaks to remote waterways.

Such bicycle towing systems are described in the patent literature. For example, Levad, U.S. Pat. No. 5,320,371 discloses a bicycle trailer suited for transporting loads such as canoes, surfboards, ladders, and the like. The trailer includes a pair of wheels and a frame arrangement having a spreading member for the wheels and a longitudinally extending load receiving rigid framework. The various members are separable so that a flexible strap, which is connected between the wheels and a part of the frame as well as the bicycle hold the frame arrangement together.

Capobianco, U.S. Pat. No. 6,032,964 discloses kayak transport device having wheels. The kayak has a hull with a pair of existing hull apertures for mounting the kayak on the kayak transport device. The kayak transport device includes a substantially H-shaped transport frame member having first and second vertical frame members, and an adjustable crossbar assembly. The crossbar assembly includes first and second crossbars that are adjustable relative to each other, the first and second crossbars being connected to the first and second vertical frame members, respectively. The crossbar assembly is adjustable for adjusting the spacing between the first and second vertical frame member to correspond to the distance between the hull apertures on the kayak hull.

Garrett, U.S. Pat. No. 10,112,690 discloses a system of brackets and rails for attaching wheels, towing, and accessory devices to a pontoon water bike. According to the '690 Patent, this system allows towing by hand, bicycle, or other small vehicle, as well as attachment of single and multiple wheels. The system of brackets and rails allows one person to move the watercraft over land by walking or biking.

Stewart, U.S. Patent Application Publication 2006/0186635 discloses a transport device for kayaks and canoes. The device includes two separate, but interdependent parts or systems/assemblies; the first part being a lightweight harness system and the second part being an axel/wheel assembly.

Hosey, U.S. Patent Application Publication 2011/0048311 discloses and apparatus for towing a kayak with a bicycle. The apparatus includes a pair of wheels, each rotatably mounted to one end of the respective arm. The arms are pivotally mounted by clamps to a crossmember which extends through a clamp mounted on the topside of the watercraft for movement between stowed positions and ground-engaging positions.

Angelow, U.S. Patent Application Publication 2013/0048311 discloses a kayak transportation device that can be used with a bicycle. The device comprises a watercraft component, a mounting component, and an axle component. A person can connect the transportation device to a bicycle so that the person can tow the kayak across land.

Although, the above-described transport devices might be effective for transporting a kayak across land, these devices are not used for transporting objects in the water. There remains a need for a kayak transport device that can be used on land and water. The device should be lightweight and easy to use. A single person should be easily capable of using such a transport device so they can tow their kayak on land to reach a waterway. The same person also should be able to use the same device for towing their kayak back to their starting point after using it on the waterway. The device also should be convertible so that a person can use it for towing objects in the water.

The present invention allows a person to use an ordinary bicycle to tow their kayak on land. The user can tow their kayak to and from a waterway. The present invention also allows a person to use their kayak to tow their bicycle while on the water. As described further below, the present invention provides a convertible flotation carrier that can be used on land and water as needed for transporting bicycles, kayaks, and other goods and apparatus.

### SUMMARY OF THE INVENTION

The present invention relates generally to a convertible flotation carrier. The flotation carrier can be used to support a kayak, and a bicycle can easily tow the flotation carrier supporting the kayak over land. In turn, the flotation carrier can be converted to transport the bicycle, and the kayak can easily tow the flotation carrier in the water.

The convertible flotation carrier can be used for supporting a towed member that is towed by a towing member. In general, the flotation carrier comprises:
a) an upper sub-assembly which provides storage for personal items such as camping equipment and supplies. This upper sub-assembly can have a netting barrier to keep the stored items separate from the lower assembly when combined for use in towing the bicycle in water. When the flotation carrier is used for towing the kayak on land this sub-assembly will enclose the kayak with the kayak resting on the top surface of the inverted lower sub-assembly. The upper and lower sections (sub-assemblies) are fastened together to provide a protective shell and supporting carrier for the kayak. This configuration is discussed further below; and
b) a lower sub-assembly which preferably has a twin hull structure with a cradle portion lying between the hulls. The cradle portion has sufficient space for storing a bicycle and at least three (3) separate wheel assemblies. The lower section (sub-assembly) also includes multiple receptacles for storing the wheel assemblies when they are detached from the flotation carrier as discussed further below. The twin hull construction of the lower sub-assembly provides less drag when a kayak is towing the flotation carrier in the water. Also, when the lower-assembly is inverted for use on land, the twin hull construction provides a cradle-like surface for securing the kayak. An extendable towing bar is also included with this assembly. This configuration is also discussed further below.

In one preferred embodiment, the towing member is a bicycle and the towed member supported by the flotation carrier is a kayak. In another preferred embodiment, the towing member is a kayak and the towed member supported by the flotation carrier is a bicycle. Thus, the flotation carrier converts between two positions, wherein the first position includes a bicycle towing member and a kayak towed member; and the second position includes a kayak towing member and a bicycle towed member.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a side elevation view of one embodiment of the flotation carrier of the present invention showing a bicycle towing the carrier on a land surface, wherein the carrier comprising upper and lower sub-assemblies is supporting a kayak;

FIG. 2 is a top view of one embodiment of the flotation carrier of the present invention showing a kayak being supported by the lower sub-assembly wherein the upper sub-assembly has been removed;

FIG. 2A is a top view of one embodiment of the flotation carrier of the present invention showing the upper sub-assembly of the flotation carrier covering the kayak;

FIG. 3 is a partial cut-away view of one embodiment of the flotation carrier of the present invention showing a kayak towing the carrier in the water, wherein the carrier contains a bicycle;

FIG. 3A is a side elevation view of one embodiment of the flotation carrier of the present invention showing a kayak towing the carrier in the water, wherein the carrier contains a bicycle;

FIG. 4 is a top view of one embodiment of a lower sub-assembly of the flotation carrier of the present invention;

FIG. 4A is a front view of the lower sub-assembly of the flotation carrier shown in FIG. 4;

FIG. 4B is a bottom view of one embodiment of an upper sub-assembly of the flotation carrier of the present invention;

FIG. 4C is a front view of the upper sub-assembly of the flotation carrier shown in FIG. 4B; and

FIG. 4D is a front view of one embodiment of the flotation carrier assembly of the present invention showing the upper sub-assembly fastened to the lower sub-assembly.

### DETAILED DESCRIPTION OF THE INVENTION

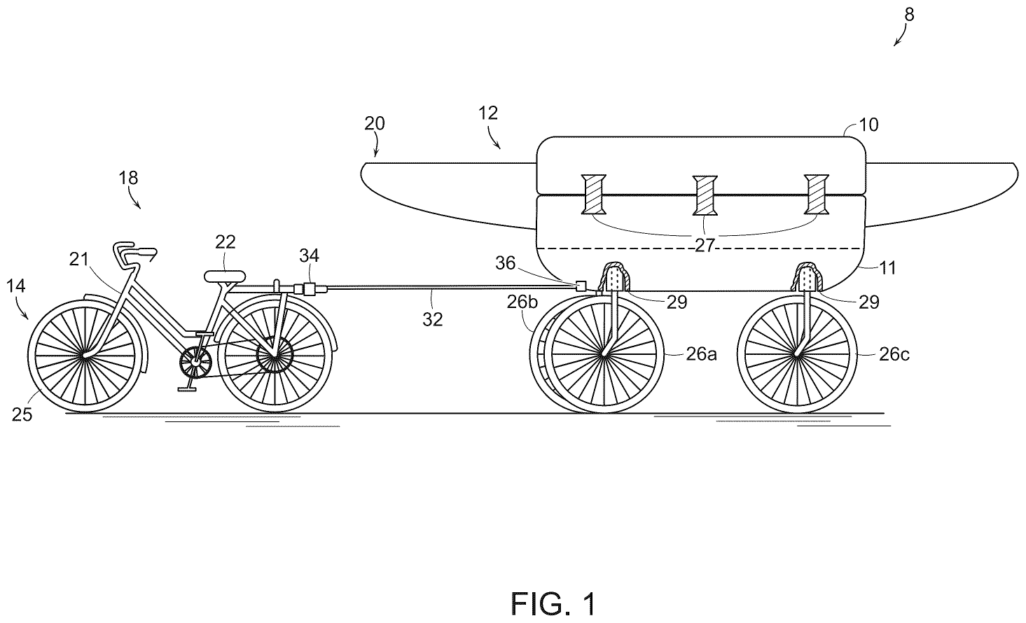

Referring to the Figures, where like reference numerals are used to designate like elements, and particularly FIG. 1, one embodiment of the convertible flotation carrier (8) is generally shown. The flotation carrier (8) comprises upper (10) and lower (11) sub-assemblies. The flotation carrier (8) supports an apparatus or member that will be towed as generally indicated at (12). A towing apparatus or member as generally indicated at (14) is used to tow the towed member (12). Examples of various towed and towing members are discussed further below. More particularly, in FIG. 1, the towing member (14) is shown as a bicycle (18) and the towed member (12) is shown as a kayak (20).

The flotation carrier (8) of the present invention comprises the upper (10) and lower (11) sections or sub-assemblies. In one embodiment, the flotation carrier (8) first supports a kayak (20); and a bicycle (18) tows the kayak (20) on land. The flotation carrier (8) is lightweight and durable so that a single person can easily tow the carrier and loaded kayak (20) with their bicycle (18). The bicycle (18) comprises a frame (21) and seat (22) and is preferably built for towing the carrier (10) on a variety of land surfaces such as, for example, beach roads, dirt trails, and grass. Then, the flotation carrier (8) is converted to support the bicycle (18); and the kayak (20) tows the bicycle (18) in the water. Although the towing member (14) and the towed member (12) are described primarily herein as being a bicycle (18) and a kayak (20) and vice versa, it is understood that a variety of apparatus can be used as either the towing or towed members. For example, other watercraft such as, for example, a boat, canoe, rowing shell, rowboat, paddleboard, and surfboard and other vehicles such as scooters, motorbikes, motorcycles, and all-terrain vehicles (ATVs) can be used as the towing and towed members.

### Land Use

The present invention allows a user to transport their kayak (20) on land. For example, the flotation carrier upper (10) and lower (11) assemblies can be converted to support the kayak (20), and the flotation carrier (8) can be hitched to a bicycle (18) as described above. Then, the user can pedal the bicycle (18) forward to transport the kayak (20). Thus, the person can ride their bicycle (18) on land, while towing the flotation carrier (8) containing the kayak (20) behind. The person can ride their bicycle (18) to a given departure point on a waterway and launch their kayak (20) in the water.

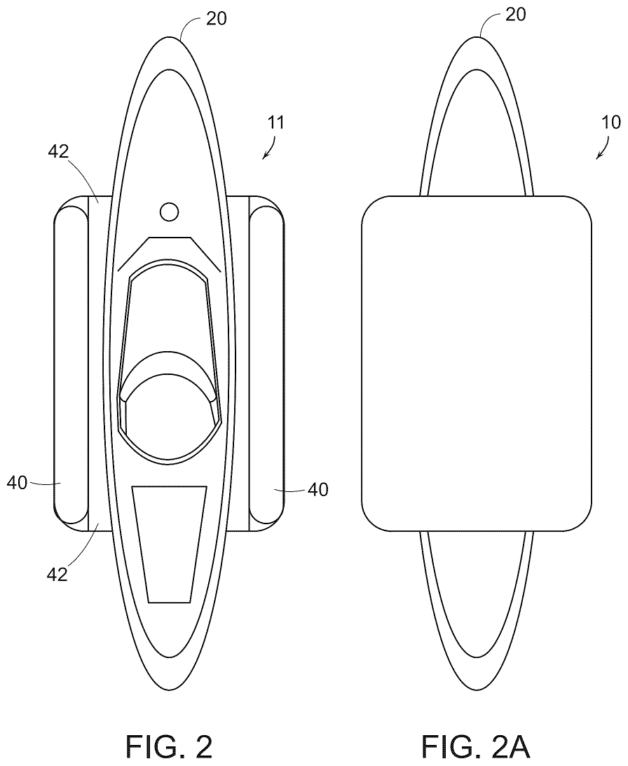

More particularly, referring to FIGS. 1, 2 and 2A, when the bicycle (18) is towing the kayak (20) on a ground surface, the flotation carrier upper (10) and lower (11) sub-assemblies are fastened together, and the kayak (18) is sandwiched between them. The upper (10) and lower (11) sub-assemblies can be fastened together interlock using any suitable fastening means (27). For example, straps, cables, ropes, ties, latches, buckles, clips snap-fit pieces, and the like can be used to fasten the upper (10) and lower (11) sub-assemblies.

A detachable tow bar (32) can be used to couple the bicycle (18) to the flotation carrier assembly (8). The tow bar (32) includes a bicycle attachment end portion (34) that is coupled to the rear of the bicycle (18); and a carrier attachment end portion (36) that is coupled to the flotation carrier lower sub-assembly (11). Different tow bars (32) can be used in accordance with this invention. In one preferred embodiment, the tow bar (32) is hinged at the bicycle (18) and flotation carrier (8) can move in different directions.

Referring to FIGS. 2 and 2A, the lower sub-assembly (11) preferably has two hulls (40) with a cradle portion (42) lying between the hulls. In this configuration, where the flotation carrier (8) is being transported over land, the twin hull structure with its intermediary cradle is in an inverted position. The cradle portion (42) provides strong underlying support for the kayak (20). As described further below, when the lower sub-assembly is inverted for use on land, the twin hull construction provides a cradle-like surface for securing the kayak.

Turning back to FIG. 1, the flotation carrier lower sub-assembly (11) further includes at least two mounted, detachable wheel assemblies. In one preferred embodiment, there are three detachable wheel assemblies. In yet other embodiments, there can be greater than three detachable wheel assemblies. In FIG. 1, one embodiment is shown, wherein a first wheel (26a) is shown mounted to the first side of the carrier lower sub-assembly (11), and a second wheel (26b) is mounted to an opposing second side of the lower sub-assembly (11). Preferably, the first-and second-wheel assemblies (26a, 26b) are fixed and move either in a forward or rear direction only. A third wheel assembly (26c) is located forwardly to the first-and second-wheel assemblies (26a, 26b). Preferably, the third wheel assembly (26c) is three-hundred and sixty degrees (360°) rotational. That is, the third wheel assembly (26c) moves in multi-directions. Alternatively, the third wheel assembly (26c) can be located rearwardly to the first-and second-wheel assemblies (26a, 26b). The first, second, and third-wheel assemblies (26a, 26b, and 26c) further include mounting members (29).

As described above, a person can ride their bicycle on land, while towing the flotation carrier and kayak behind their bicycle. The present invention allows a person to use an ordinary bicycle to tow the kayak to and from the water.

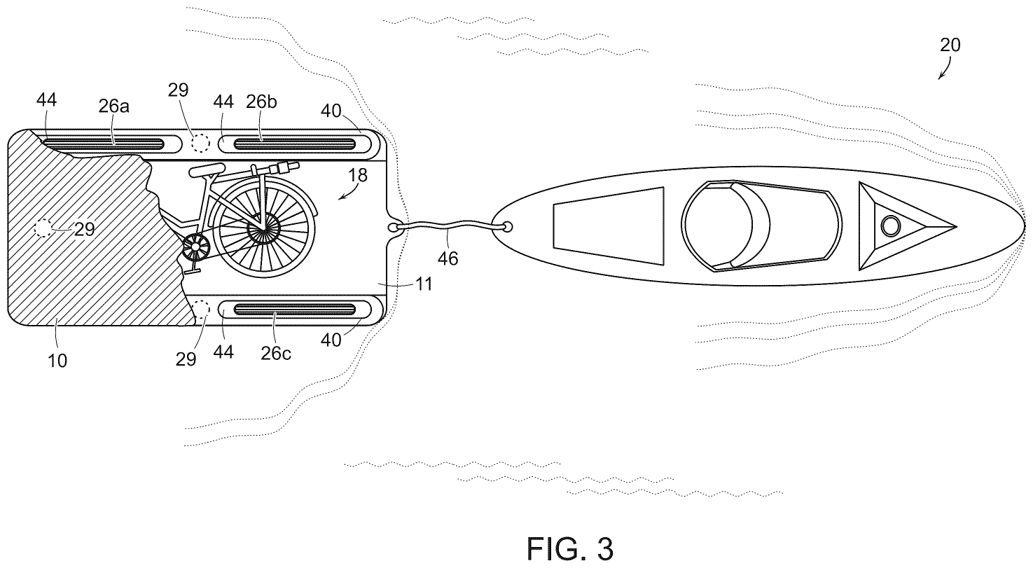

The present invention also allows the user to transport their bicycle (18) on the water. For example, as described above, a person can first use the flotation carrier (8) to transport their kayak (20) over land. A bicycle (18) is used to tow the kayak (20). Then, the kayak (20) can be removed from the flotation carrier (8) and placed in the water. Next, the lower carrier sub-assembly (11) can be inverted, and the bicycle (18) can be loaded onto the lower sub-assembly (11) along with the three detachable wheel assemblies (26a, 26b, and 26c) that are described above. These three separate wheel assemblies (26a, 26b, and 26c) can be loaded into receptacles or chambers (44) located in the lower carrier sub-assembly (11). As shown in FIG. 3, the chambers (44) are located around the edges of the lower carrier sub-assembly (11). The final flotation carrier assembly (8), wherein the upper sub-assembly (10) is fastened to the lower sub-assembly (11) provides an airtight and water-proof vessel for the bicycle (18). The flotation carrier (8), which carries the bicycle (18), is lightweight and durable.

### Water Use

In the water, the flotation carrier (8) can be hitched to the kayak (20), and the user can paddle forward. Thus, the person can travel in their kayak (20) on water, while towing the flotation carrier (10) and bicycle (18) behind their kayak (20). Eventually, when the kayaker reaches their destination point in the water, he/she removes the kayak (20) from the water and loads it back onto the convertible flotation carrier (8) as described in the Land Use section above. The kayaker hitches the flotation carrier (8) supporting the kayak (20) to the bicycle (18) and then pedals the bicycle forward. The user can then tow the kayak (20) to another departure point in the water or back to his/her original starting point.

More particularly, referring to FIG. 3, when the bicycle rider reaches their given departure point in the waterway, he/she is now ready to convert the flotation carrier (10). In practice, the bicycle (18) is unhitched from the flotation carrier (8). The tow bar (32) is disconnected and the wheel assemblies (26a, 26b, and 26c) are detached. The tow bar and wheel assemblies can be stored in the lower sub-assembly (11), particularly in the provided storage areas (44) located in each of the twin hull cavities (40). Once the bicycle (18) is unhitched from the flotation carrier (10), it can be placed on and secured to the cradle portion (42). in the lower sub-assembly (11). Then, the upper sub-assembly (10) can be fastened to the lower subassembly (11) to provide an airtight, water-proof chamber as described above.

Next, the flotation carrier (8) is fastened to the kayak (20) in the water. Any suitable fastening means can be used for coupling the flotation carrier (10) to the kayak (20). For example, the flotation carrier (8) can be connected to the kayak (20) by a tow rope, cable, or the like (46) as shown in FIGS. 3 and 3A. Because the flotation carrier (8) has two hulls (40) the combined flotation carrier assembly (8) is both buoyant and easily towable on the water. Furthermore, the upper (10) and lower (11) sub-assemblies, when fastened together, forms an airtight and watertight interior compartment. This secure interior compartment encloses the kayak or bicycle.

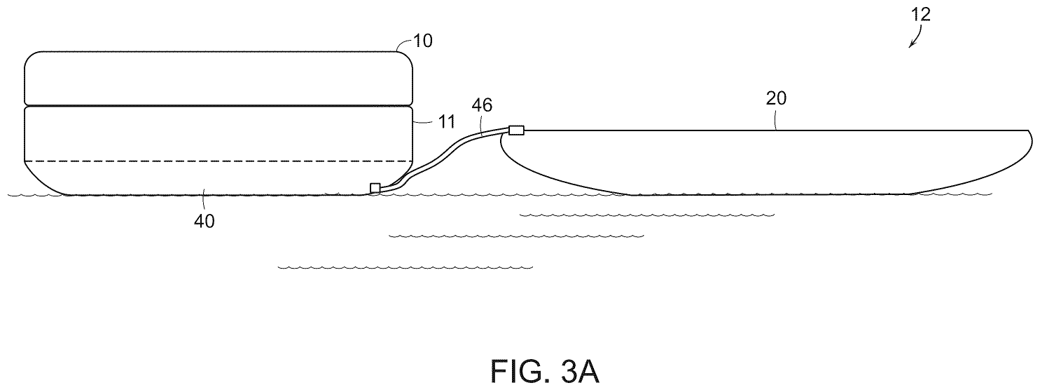

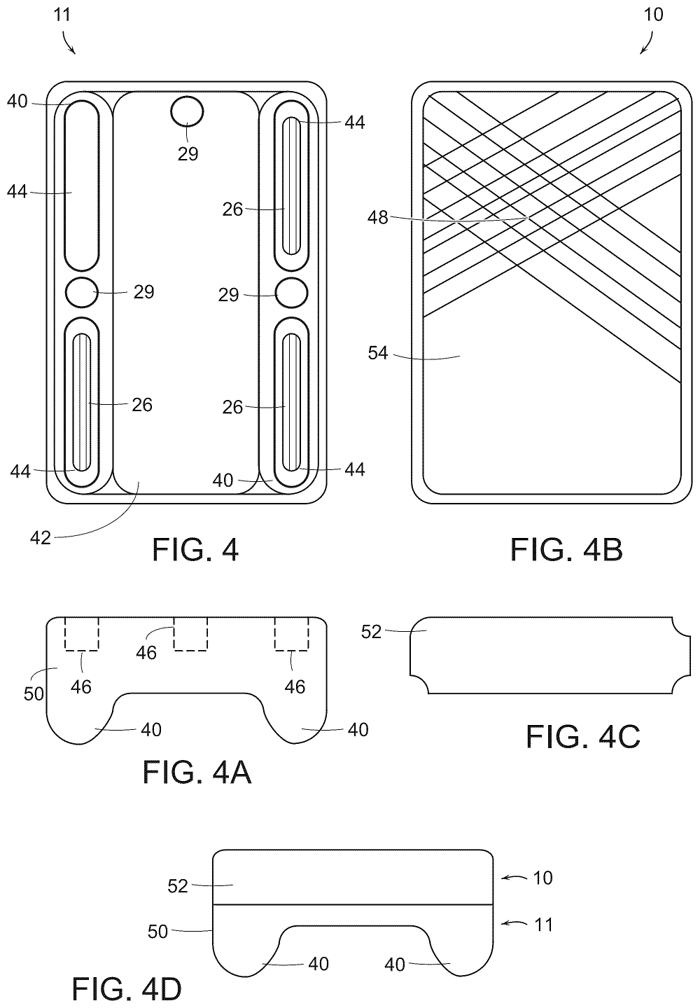

Referring to FIGS. 4-4D, a top-down view of the lower sub-assembly (11) is shown in FIG. 4, and a front-view of the lower sub-assembly (11) is shown in FIG. 4A. As discussed above, the lower sub-assembly (11) includes the twin hulls (40) and an intermediary cradle portion (42) for supporting the bicycle (18) or kayak (20). In FIG. 4A, the front section (panel) (50) of the lower sub-assembly (11) is shown with the twin hulls (40). When the flotation carrier assembly (8) is being used in the water, the twin hulls (40) help the flotation carrier (8) to cut and move easily through the water. In FIG. 4B, a bottom view of the upper subassembly (10) is shown. The interior surface (54) of the upper sub-assembly (10) preferably includes cargo netting (48) that can be used for storing various articles such as food and beverages, first-aid kits, tools, clothing, tents, camping equipment, and the like. It should be understood that when the flotation carrier (8) is being towed in the water, the receptacles in the lower sub-assembly (11) can be used for storing various articles such as the items described above and the like. In FIG. 4C, the front section (panel) (52) of the upper sub-assembly (10) is shown. Turning to FIG. 4D, a front view of the complete flotation carrier assembly including the upper sub-assembly (10) and lower sub-assembly (11) is shown.

The upper (10) and lower (11) sub-assemblies can be made of various materials such as, for example, polyacrylonitrile butadiene styrenes (ABS), high-density polyethylenes (HDPE), polypropylenes, polycarbonates, polyamide-imide copolymers, polystyrene, polyethylene terephthalates, polyvinyl chlorides, acrylics, and fiberglass, and blends thereof. The material should be lightweight and have high toughness and impact-resistance. In addition, the material should be relatively easy to process so that it can be molded or otherwise shaped into the flotation carrier, upper and lower sub-assemblies, and other constructed products of this invention. Plastics and other materials having different tensile strength, flex modulus, impact durability, and other properties can be used depending on the desired support strength of the constructed products.

As described above, a person can first use the flotation carrier assembly (8)

comprising the upper sub-assembly and lower sub-assembly (11) of the present invention on land. The flotation carrier (8) can be converted to support a kayak (20), and the carrier can be hitched to the rear of a bicycle (18). Then, the user can pedal their bicycle (18) forward while towing the kayak (20) to the waterway. Once the bicycle rider reaches their water departure point, the kayak (20) can be removed from the carrier assembly (8) and placed in the water. Next, the bicycle (18) can be loaded into the flotation carrier (8). In the water, the flotation carrier (8) can be hitched to the rear of the kayak (20) and the user can paddle forward while towing the bicycle (18) behind on the waterway. Thus, a person can travel in their kayak (20) on water, while towing the flotation carrier (8) and bicycle (18) behind their kayak (20). One advantage of the flotation carrier assembly (8) of this invention is that the user has easy access to the lower sub-assembly (11) for loading and unloading the kayak (20) and bicycle (18).

The convertible flotation carrier (8) of the present invention is lightweight and easy to use. A single person can easily use the flotation carrier to tow their kayak on land to reach a waterway. The same person also can use the same device for towing their kayak back to their starting point after using it on the waterway. Thus, there is no need for having a vehicle at both the original water departure point and final water destination point. A person can use a bicycle easily to carry the kayak to and from the water. No cars, trucks, or other motorized vehicles are needed to transport the kayak.

It should be understood the terms, “first”, “second”, “third”, “top”, “bottom”, “upper”, “lower”, “upwardly”, “downwardly”, “forwardly”, “rearwardly”, “right”, “left”, “interior”, exterior” and the like are arbitrary terms used to refer to one position of an element based on one perspective and should not be construed as limiting the scope of the invention.

It is understood that the flotation carrier device, components, materials, and constructions described and illustrated herein represent only some embodiments of the invention. It is appreciated by those skilled in the art that various changes and additions can be made to the device and constructions without departing from the spirit and scope of this invention. It is intended that all such embodiments be covered by the appended claims.

1. A convertible flotation carrier assembly for supporting a towed member that is towed by a towing member on a land surface, the flotation carrier comprising:
a lower sub-assembly having a first hull and second hull, wherein a cradle portion is disposed between the first and second hulls, the cradle portion having a top surface for supporting the towed member;
at least two detachable wheel assemblies, the wheel assemblies being mounted to the lower subassembly; and
an upper sub-assembly having a top cover, the upper assembly being fastened to the lower subassembly to define an interior compartment for holding the towed member.

2. The convertible flotation carrier of claim 1, wherein the lower assembly further comprises a towing bar for coupling the towed member to the towing member.

3. The convertible flotation carrier of claim 1, wherein the upper sub-assembly is fastened to the lower sub-assembly by fastening straps.

4. The convertible flotation carrier of claim 1, wherein there are three detachable wheel assemblies.

5. The convertible flotation carrier of claim 1, wherein the towing member is selected from the group consisting of a bicycle, scooter, motorbike, motorcycle, and all-terrain vehicle.

6. The convertible flotation carrier of claim 1, wherein the towed member is selected from the group consisting of a kayak, boat, canoe, rowing shell, rowboat, paddleboard, and surfboard.

7. The convertible flotation carrier of claim 1, wherein the towing member is a bicycle and the towed member is a kayak.

8. The convertible flotation carrier of claim 1, wherein the upper sub-assembly contains cargo netting.

9. The convertible flotation carrier of claim 1, wherein the lower sub-assembly contains storage chambers.

10. A convertible flotation carrier assembly for supporting a towed member that is towed by a towing member in water, the flotation carrier comprising:
a lower sub-assembly having a first hull and second hull, wherein a cradle portion is disposed between the first and second hulls, the cradle portion having a top surface for supporting the towed member; and
an upper sub-assembly having a top cover, the upper assembly being fastened to the lower subassembly to define an interior compartment for holding the towed member.

11. The convertible flotation carrier of claim 10, wherein the lower assembly further comprises a towing rope for coupling the towed member to the towing member.

12. The convertible flotation carrier of claim 10, wherein the upper sub-assembly is fastened to the lower sub-assembly by fastening straps.

13. The convertible flotation carrier of claim 10, wherein the towing member is selected from the group consisting of a kayak, boat, canoe, rowing shell, rowboat, paddleboard, and surfboard.

14. The convertible flotation carrier of claim 10, wherein the towed member is selected from the group consisting of a bicycle, scooter, motorbike, motorcycle, and all-terrain vehicle.

15. The convertible flotation carrier of claim 10, wherein the towing member is a kayak, and the towed member is a bicycle.

16. The convertible flotation carrier of claim 10, wherein the upper sub-assembly contains cargo netting.

17. The convertible flotation carrier of claim 10, wherein the lower sub-assembly contains storage chambers.

18. The convertible flotation carrier of claim 17, wherein wheel assemblies are placed in the storage chambers.
